(19) United States
(12) Patent Application Publication
(10) Pub. No.: US 2016/0259840 A1
(43) Pub. Date: Sep. 8, 2016

(54) PERSONALIZING USER INTERFACE (UI) ELEMENTS

(71) Applicant: Yahoo! Inc., Sunnyvale, CA (US)

(72) Inventors: Hao Zheng, Beijing (CN); Yu Zou, Beijing (CN); Ming Chang, Beijing (CN); Hongwei Zeng, Beijing (CN)

(21) Appl. No.: 14/405,971

(22) PCT Filed: Oct. 16, 2014
(86) PCT No.: PCT/CN2014/088704

§ 371 Date: Dec. 5, 2014

(51) Int. Cl. G06F 17/30; G06Q 30/02; G06F 17/22

(52) U.S. Cl. CPC G06F 17/30598; G06F 17/2247; G06F 17/30905; G06F 17/30917; G06Q 30/0277; G06Q 30/0269

(57) ABSTRACT

This disclosure relates to personalizing user interface (UI) elements of online content (a website, a mobile application, etc.) presented on a user device. The UI personalization technique may include, for a current online session, processing user-related data and context-related data to determine the UI element(s) and their attribute value(s) to be used for presentation of the online content during the current session. The user-related data include information regarding the user/user device, and the context data may include details about the online content (content type/topic, default UI attribute values, etc.) being accessed in the given online session. The user data and the context data may be processed based on modeling data related to users and their interaction with the UI of online content from different publishers and/or advertisers. Based on such processing, personalized UI element(s) and attribute values are determined and the online content is presented with the personalized UI.

### BACKGROUND

1. Technical Field

The present teaching relates to personalizing or modifying user interface for online content.

2. Discussion of Technical Background

Typically, websites or mobile applications (or “apps”) including content and advertisements (or “ads”) are rendered with certain graphical user interface characteristics on mobile devices and non-mobile devices (e.g., personal computers, laptops, etc.). Such a user interface has a number of user interface elements (e.g., text color, text size, etc.) that may be modified or optimized to alter the overall experience a user has with the provided content and/or ads.

However, to effectively optimize the user interface for a certain user such that the user has an improved personalized interaction with and, hence, provides a higher response rate (e.g., in terms of ad clicks, etc.) to the content and/or ads, what is needed is a relatively large set of data including user data for one or more groups of users, data about contextual features of online content/ads accessed by the users, and data about users' response to the contextual features.

Individual players in the online advertising market including publishers, advertisers and ad networks may not have the scale or the needed data to learn and in real-time optimize or personalize the user interface for the content provided to their user(s). Indeed, for individual publishers, advertisers, etc., per user user-interface related data tends to be very sparse, which may not make effective and accurate user-interface personalization possible.

Accordingly, what is needed is a solution that can utilize data indicating users' interaction with and response to multiple user-interface (“UI”)-related contextual features to personalize the user interface for the website or app accessed by the user(s).

### SUMMARY

The disclosure provided herein relates to methods, systems, and programming to personalize user interface (UI) elements of online content (e.g., webpages, websites, Internet-based applications installed on wireless/mobile devices, etc., and/or advertisements provided on or in relation to webpages, websites, Internet-based applications, etc.). More particularly, the present disclosure relates to methods, systems, and programming to personalize user interface (UI) elements of online content presented to a certain user during a given online session in which the user is accessing the online content.

In one aspect of the disclosure, a method, implemented on a machine having at least one processor, storage, and a communication platform connected to a network to personalize user interface (UI) elements of online content, is disclosed. In this method, data related to a user/user device and context data is received, e.g., by the communication platform of the machine. The context data may include information related to the online content (content type, content style, default UI attributes/parameters of the content, etc.) accessed by the user, e.g., on the user device. Further, user-and-context modeling data may be obtained, where the user-and-context modeling data includes data related to a plurality of users and their interaction with a plurality of webpages, applications or other content (having certain UI attributes) provided by a number of publishers and/or advertisers. A personalized property or attribute with respect to at least one of the UI elements to be used to present the webpage or the application at the user device is determined, e.g., based on the data related to the user and the context data in accordance with the user-and-context modeling data. The UI elements of the online content that may be considered for personalization include text fonts, border, background, icons, buttons, menus and/or other known UI elements. Further, the attributes of the UI elements that may be personalized may include text font size, text font style, text font color, bold (or other emphasis) on certain portions of text, page layout, background color, background images, border color, border style, border size, “mouse over” behavior, icon/button arrangements, icon/button size, icon/button shape, menu color, length of text of search results, length of each field, truncation/shortening rules, animation/multimedia effects and image/thumbnail placement rules.

In another aspect of the disclosure, a system to personalize UI elements of online content is disclosed. The system includes a communication platform, a modeling data unit, and a UI personalization engine. The communication platform may be configured to receive data related to a user and context data including information related to a webpage or an application to be accessed by the user on a user device, wherein the webpage or the application includes one or more UI elements. The modeling data unit may be configured to obtain and process user-and-context modeling data related to a plurality of users, a plurality of webpages and applications and the interactions therebetween. The UI personalization engine may be configured to determine a personalized property with respect to at least one of the one or more UI elements to be used to present the webpage or the application at the user device based on the data related to the user and the context data in accordance with the user-and-context modeling data.

Other concepts relate to software for implementing the personalization of UI elements of online content. A software product, in accord with this concept, includes at least one machine-readable non-transitory medium and information carried by the medium. In one example, a machine readable and non-transitory medium having information recorded thereon to personalize UI elements of online content, where when the information is read by the machine, causes the machine to receive data related to a user and context data including information related to a webpage or an application to be accessed by the user on a user device. Further, user-and-context modeling data related to a plurality of users, a plurality of webpages and applications and the interactions therebetween may be obtained and processed. Based on the data related to the user and the context data in accordance with the user-and-context modeling data, a personalized property or attribute with respect to at least one of the one or more UI elements may be determined The personalized UI element(s) for the webpage or application may be provided to the corresponding publisher/advertiser to present the personalized webpage or application at the user device.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1(a)-1(c) illustrate examples of systems in which the UI personalization is implemented in accordance with various embodiments of the present disclosure;

FIG. 2 illustrates an exemplary data structure to store user-and-context modeling data in a database, according to an embodiment of the present disclosure;

FIG. 3 is a high level depiction of an exemplary personalized UI unit, according to an embodiment of the present disclosure;

FIG. 4 is a high level depiction of an exemplary UI personalization engine, according to an embodiment of the present disclosure;

FIG. 5 is a flowchart of an exemplary process operated at the UI personalization engine, according to the embodiment described above with respect to FIG. 4;

FIG. 6 is a flowchart of an exemplary process operated at the personalized UI unit, according to the embodiment described above with respect to FIG. 3;

FIG. 7 depicts a general mobile device architecture on which the present teaching may be implemented; and

FIG. 8 depicts a general computer architecture on which the present teaching may be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods and other implementations directed to personalizing one or more user interface (UI) elements of a webpage/website or a mobile application (or generally referred to herein as “online content”) provided to and rendered on a user computing device (e.g., mobile phone, personal computer, etc.). The disclosed UI personalization technique includes, for a given online session in which a user is accessing certain online content, processing user-related data and context-related data to determine parameter or property values for one or more UI elements to be used for presentation of the online content during the given session. The user-related data may include (personal) information regarding the user and information related to a device the user is using to access the online content. Further, the context data may include various details about the online content being accessed in the given online session. In some embodiments, the publisher (or any other entity), that is hosting, supporting and/or providing to the user the online content in the given online session, collects and provides both the user data and the context data to another device, system, apparatus, and/or functional module configured to process of such data and determine UI personalization parameters.

In some embodiments, the processing of such data is based on (previously collected and stored) user-and-context modeling data related to a plurality of users and their interaction with the UI of a plurality of webpages and applications related to a number of publishers and/or advertisers. Based on such processing of the user data and the context data, personalized property or parameter values of the UI element(s) (e.g., font size, font color, etc.) of the accessed online content are determined The personalized UI property or parameter values so determined may be specific for the user accessing the online content in a given online session. The personalized property values of the UI element(s) are then provided to the publisher or advertiser related to the online content, such that the online content is made available and rendered (or otherwise presented) on the user device according to the personalized property values of the UI element(s).

Providing the webpage or app with the UI that is personalized for a user (e.g., based on prior data related to users' interaction with variety of online content having various different UI features) may improve the overall experience and interaction the user has with the webpage or app. For example, having provided a webpage/app with personalized UI, as compared to the webpage/app with no UI personalization, a user may spend/dwell more time consuming (e.g.., reading) the contents on the webpage/app, click on more number of links provided on the webpage/app, click on and convert more number of ads presented with the webpage/app, etc.

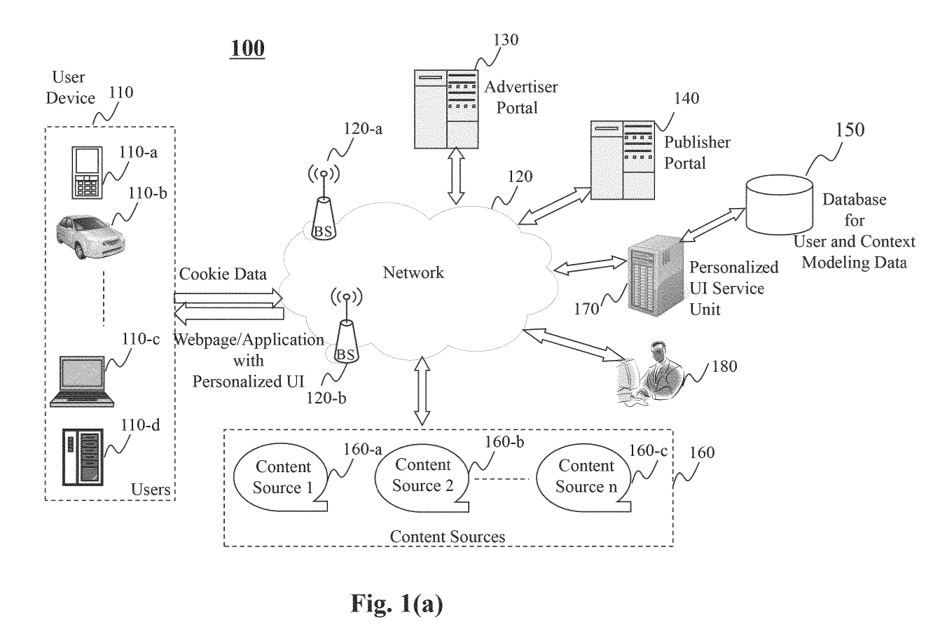

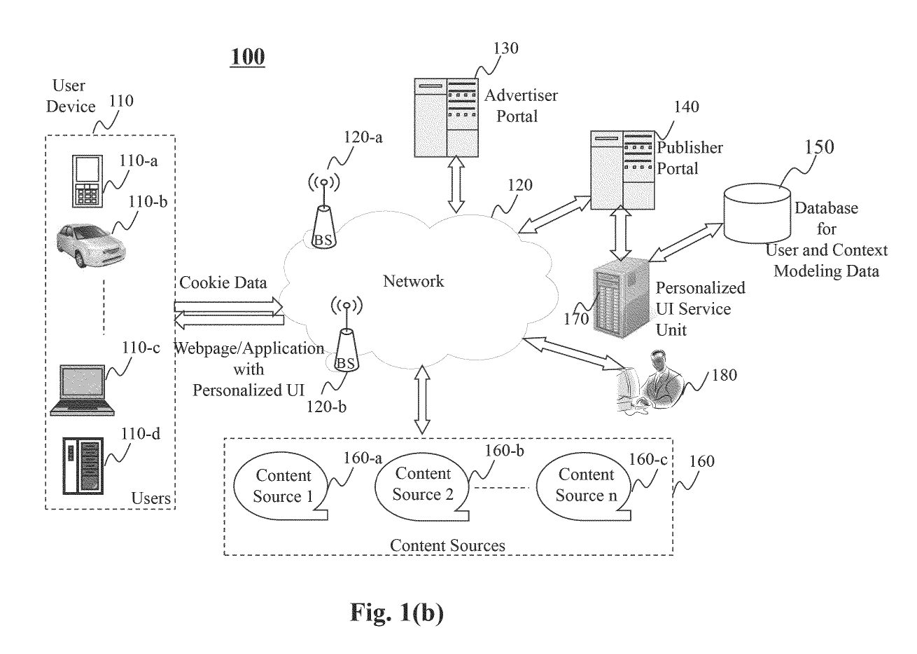

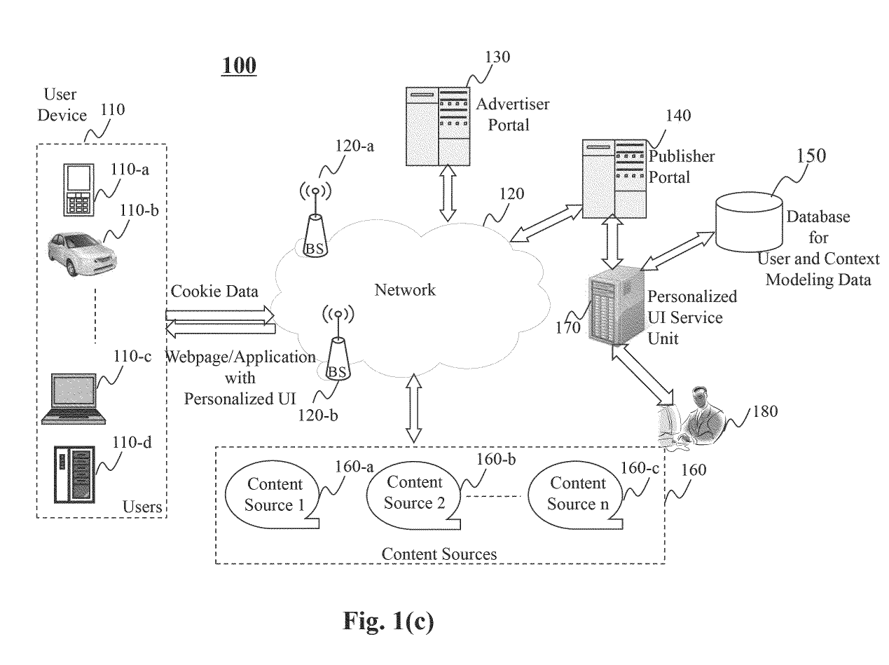

FIGS. 1(a)-1(c) are high level depiction of different system configurations in which one or more UI personalization techniques may be implemented, according to one or more embodiments of the present disclosure. In FIG. 1(a), the exemplary system 100 includes users 110, a network 120, one or more publisher portals or publishers 130, one or more advertisers 140, a user-and-context data database 150, content sources 160 including content source 1 160-a, content source 2 160-b, . . . , content source n 160-c, a personalized UI service unit 170, and a system operator/administrator 180.

The network 120 may be a single network or a combination of different networks. For example, a network may be a local area network (LAN), a wide area network (WAN), a public network, a private network, a proprietary network, a Public Telephone Switched Network (PSTN), the Internet, a wireless network, a cellular network, a virtual network, or any combination thereof. A network may also include various network access points, e.g., wired or wireless access points such as base stations or Internet exchange points 120-a, . . . , 120-b, through which a data source may connect to the network in order to transmit information via the network. In one embodiment, the network 120 may be an online advertising network or an ad network, which connects advertisers 140 to publishers 130 or websites/mobile applications that want to host advertisements. A function of an ad network is aggregation of ad-space supply from publishers and matching it with advertiser demand. An ad network may be a television ad network, a print ad network, an online (Internet) ad network, or a mobile ad network.

Users 110 may be of different types such as users connected to the network via desktop connections (110-d), users connecting to the network 120 via wireless connections such as through a laptop (110-c), a handheld device (110-a), or a built-in device in a motor vehicle (110-b). In one embodiment, user(s) 110 may be connected to the network 120 and able to access and interact with online content (provided by the publishers 130) through wireless technologies and related operating systems and interfaces implemented within user-wearable devices (e.g., glasses, wrist watch, etc.). A user, e.g., 110-1, may send a request for online content and/or a search query to the publisher 130, via the network 120 and receive content as well as one or more advertisements/ads (provided by the advertiser 140) through the network 120. The online content and ads may be provided and rendered on (e.g., a display of) the user device with a specific UI layout having multiple different UI elements (e.g., font size, font color, background color, etc.) with certain pre-configured values. The user 110-1 may click on or otherwise interact with the content and/or select the ad(s) to review and/or purchase the advertised product(s) or service(s). In the context of the present disclosure, such ad presentation/impression, ad click-through rate, ad conversion, dwell time and information related to other user interactions with the online content having certain UI-based properties or values may be recorded to update the database 150 storing user-and-context data.

In some embodiments, as will be described in further detail below, the UI personalization techniques described herein include processing data related to a user 110 and a device that the user 110 is using to access the online content. Such “user” data may include one or more of user cookie data (e.g., in relation to accessing one or more particular websites or apps), user device IP address or MAC address, user geographical location data, type of user device (mobile phone, tablet computer, laptop, etc.), user log-in or account information specific to a certain websites or apps, user UI-based preference information related to certain websites or apps, data indicating user interaction with the webpage or app the user is currently accessing, and/or other user- or user-device-related data. Such user data may be provided to the personalized UI unit 170 for further processing either directly from the user 110, or from the publisher 130 which is providing the online content being accessed by the user 110, and/or from another database (not shown) that is configured to collect and store such user data.

Publishers 130, may correspond to an entity, whether an individual, a firm, or an organization, having publishing business, such as a television station, a newspaper issuer, a web page host, an online service provider, or a game server. For example, in connection to an online or mobile ad network, publishers 130 may be an organization such as USPTO.gov, a content provider such as CNN.com and Yahoo.com, or a content-feed source such as Twitter or blogs. In one embodiment, publishers 130 include entities that develop, support and/or provide online content via mobile applications (e.g., installed on smartphones, tablet devices, etc.). In one example, the content sent to user 110-1 may be generated or formatted by the publisher 130 based on data provided by or retrieved from the content sources 160. A content source may correspond to an entity where the content was originally generated and/or stored. For example, a novel may be originally printed in a magazine, but then posted online at a web site controlled by a publisher. The content sources 160 in the exemplary networked environment 100 include multiple content sources 160-1, 160-2 . . . 160-3.

The online content (including ads) provided by the publishers 130 is associated with a number of UI elements that define the overall presentation of the online content on the user device 110. For example, the UI elements related to websites, webpages or apps include, but not limited to, font size, font style, font color, bold (or other emphasis) on certain portions of text, page layout, background color, background images, border color, border style, border size, “mouse over” behavior, icon/button arrangements, icon/button size, icon/button shape, menu color, length of text of search results, length of each field, truncation/shortening rules, animation/multimedia effects and image/thumbnail placement rules.

For a given online session in which a user 110 is trying to access the online content provided by a publisher 130, the online content may be presented and rendered on the user device with default values or properties for the one or more of the above UI elements (i.e., with UI elements not modified specifically for that user 110). However, as part of the UI personalization techniques discussed herein, parameter values or properties of one or more of the UI elements are determined (e.g., by the personalized UI service unit 170), and then adapted and implemented by the publisher 130 in presenting the online content to the user 110.

Accordingly, if that publisher 130 is to provide UI personalization (e.g., as an extra feature for their users or members), the publisher 130 may provide “context” data related to the content and ads presented in the given online session (and the user data) to the personalized UI service unit 170 to determine personalized UI element values. In some embodiments, the context data include uniform resource locator (URL) of the webpage/app, information associated with the content and ads of the webpage or app (content topic—sports, news, etc.; content format—multimedia, text; etc.), internet browser, details associated with a search query submitted by the user, the (default) property values of the one or more UI elements associated with the webpage/app being accessed, webpage metadata, user labels, and/or other content attributes.

Advertisers 140, generally, may correspond to an entity, whether an individual, a firm, or an organization, doing or planning to do (or otherwise involved in) advertising business. As such, an advertiser 140 may be an entity that provides product(s) and/or service(s), and itself handles the advertising process for its own product(s) and/or service(s) at a platform (e.g., websites, mobile applications, etc.) provided by a publisher. For example, advertisers 140 may include companies like General Motors, Best Buy, or Disney. In some other cases, however, an advertiser 140 may be an entity that only handles the advertising process for product(s) and/or service(s) provided by another entity.

Advertisers 140 may be entities that are arranged to provide online advertisements to publisher(s) 130, such that those advertisements are presented to the user 110 with other online content at the user device. Advertisers 140 may provide streaming content, static content, and sponsored content. Advertising content may be placed at any location on a content page or mobile app, and may be presented both as part of a content stream as well as a standalone advertisement, placed strategically around or within the content stream. In some embodiments, advertisers 140 may include or may be configured as an ad exchange engine that serves as a platform for buying one or more advertisement opportunities made available by a publisher (e.g., publisher 130). The ad exchange engine may run an internal bidding among multiple advertisers associated with the engine, and submit a suitable bid to the publisher, after receiving and in response to a bid request from the publisher.

The content sources 160 may include multiple content sources 160-a, 160-b, . . . , 160-c. A content source may correspond to a web page/app host corresponding to a publisher (e.g., publisher 130) an entity, whether an individual, a business, or an organization such as USPTO.gov, a content provider such as CNN.com and Yahoo.com, or content feed source such as Twitter or blogs. Content sources 110 may be any source of online content such as online news, published papers, blogs, on-line tabloids, magazines, audio content, image content, and video content. It may be content from a content provider such as Yahoo! Finance, Yahoo! Sports, CNN, and ESPN. It may be multi-media content or text or any other form of content comprised of website content, social media content, such as Facebook, Twitter, Reddit, etc., or any other content rich provider. It may be licensed content from providers such as AP and Reuters. It may also be content crawled and indexed from various sources on the Internet. Content sources 110 provide a vast array of content to publishers 130 and/or other parts of system 100.

In some embodiments, the user-and-context database 150, which may be centralized or distributed, collects, stores and provides “user-and-context modeling” data related to one or more groups of the users 110 that access and interact with the variety of online content having various different UI attributes provided by one or more groups of the publishers 130/advertisers 140. For example, the publishers 130, the advertisers 140 and the personalized UI unit 170 may be operatively connected with the database 150. From those different entities of system 100, the database 150 may receive the user data associated with one or more users 110 and the context data associated with the content/ads accessed by the users 110 in one or more online sessions. In some embodiments, the database 150 is configured to store the received data in a certain pre-configured data structure. To that end, the publishers 130, the advertisers 140 and the personalized UI unit 170 may send the data pre-configured or pre-formatted in the form appropriate for the data structure at the database 150.

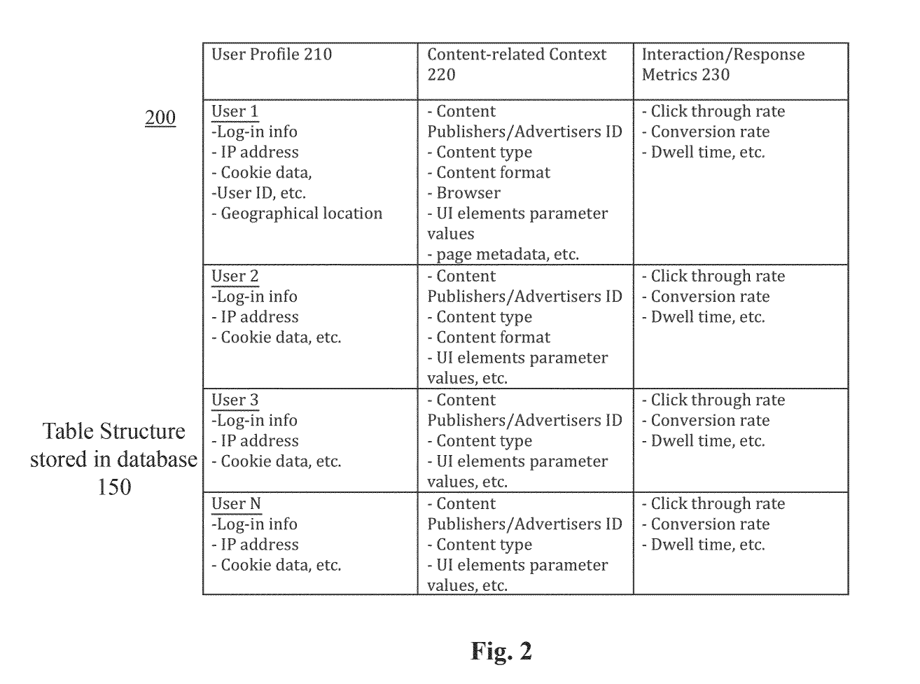

In some embodiments, the database 150 formats and stores data in relation to (or in a form which is arranged around) a specific entity of system 100. For example, the database 150 may store data as “user-centric,” in which the database 150 may create a table structure 200, as shown in FIG. 2. In the table structure 200, a profile 210 for each user 110 (or for each known identity of user 110), referenced as “user 1” “user 2,” etc., is stored in relation with associated context data 220 related to the content provided by one or more of the publishers 130/advertisers 140 to that user 110, and user interaction/response metrics 230 related to the provided content and their UI elements as measured or recorded by the respective publisher 130/advertiser 140. In this form, any new UI-related data (obtained from many different publishers and/or advertisers) for a particular user 110 or a particular group of users 110 may be tracked, maintained and updated in their respective profiles in the database 150. In some embodiments, the personalized UI unit 170 may be configured to send to the database 150 user data and context data, and results of the UI personalization, for a certain set of user 110, publisher 130 and advertiser 140 to update the profile of the user 110.

In some embodiments, in a first instance, a publisher 130 may present certain content and ads to a particular user 110 with default UI property values, measure a first set of user response metrics, and forward the first set of user response metrics to the database 150 to be stored with respect to the (new or existing) profile of the particular user 110. In a second instance, the same publisher 130 may utilize the UI personalization service from the personalized UI unit 170 to optimize one or more UI elements of the same content provided to the same user 110, and present the UI personalized content to the user 110. The publisher 130 may then measure a second set of user response metrics for the UI personalized content, and forward the second set of user response metrics to the database 150 to be stored with respect to the profile of the user 110. As such, in this implementation, the table 200 may include user profiles associated with two sets of user response metrics, one with regard to no UI personalization and the other with UI personalization.

In addition to, or instead of, arranging and storing data in terms of “user profiles” as shown in table 200, the database 150 may be configured to arrange and store data in other similar formats or structures, such as in terms of “publisher profiles,” “advertiser profiles,” “user response metric profiles,” etc. Further, it would be readily understood by a person of ordinary skill in the art that there may be various different techniques in which the data at the database 150 may be formatted, arranged, aggregated selectively accessed, grouped and/or otherwise manipulated across various different dimensions for the purposes of UI personalization and/or other purposes.

Personalized UI unit 170 may be configured to receive (or retrieve) and process, for a given user session, (a) user data related to the user(s) 110 accessing certain content and ads at a publisher 130's website/app, and (b) context data related to the content and ads being presented to the user 110 in the given user session. The processing at the personalized UI unit 170 may (a) identify or select UI element(s) from a plurality of possible UI elements that may be personalized for presentation of the content/ads to the user 110 during the given session, and (b) determine specific parameter or attribute values for the identified UI elements to be used when presenting the content/ads to the user 110 during the given session. As discussed above, the user-related data may include (personal) information regarding the user and information related to a device the user is using to access the online content. Further, the context data may include various details about the online content/ads being accessed in the given session. In some embodiments, the publisher 130 which needs to personalize the UI element(s) for the user 110 initiates the UI personalization service by the personalized UI unit 170 by providing the user data and the context data. In that regard, the personalized UI unit 170 may be referred as a provider of Personalized UI as a Service or “PUIaas.”

In some embodiments, the personalized UI unit 170 processes the received user data and context data based at least on user-and-context modeling data from the database 150. Based on such processing, the personalized UI unit 170 identifies UI element(s) (e.g., font, border, etc.) that may be personalized, and determines personalized property or parameter values of the identified UI element(s) (e.g., font size, font color, border size, etc.) of the accessed online content. The personalized UI property or attribute value(s) so determined may be specific for the user 110 accessing the online content in the given user session. The personalized property values of the UI element(s) for the online content are then provided to the publisher 130 (who initially requested the UI personalization service). The publisher 130, in the same given session, then provides the content to the user 110 such that it is rendered (or otherwise presented) on the user device according to the personalized UI element(s) (instead of the default UI property value(s)). In other words, for example, the content is rendered on the user device with the specific font size, font color, etc. that were determined by the personalized UI unit 170 for UI personalization.

In addition to a user at 110, a different type of user such as 180, which may be a system operator or an administrator, may also be able to interact with different components of system 100, e.g., personalized UI unit, etc. for different administrative jobs such as managing the database 150, etc. In some embodiments, user 180 may be classified to have a higher privilege to manage database 150 on more operational issues than user 110. For example, user 180 may be configured to be able to update the indexing scheme or format of data stored in the database 150, and the format of data received from the publishers 130/advertisers 140 to be processed at the personalized UI unit 170. In some embodiments, the personalized UI unit 170 and the database 150 may be part of a third party service provider so that the publishers 130 and advertisers 140 may be customers of the personalized UI unit 170.

FIG. 1(b) presents a similar system configuration as what is shown in FIG. 1(a) except that the publishers 130 are directly connected to the personalized UI unit 170. In some embodiments, as shown in FIG. 1(c), there may be yet another different system configuration in which the administrator user 180 may solely manage the personalized UI unit 170 and the database 150 via an internal or proprietary network connection (not shown). It is noted that different configurations as illustrated in FIGS. 1(a)-1(c) may also be mixed in any manner that is appropriate for a particular application scenario. For example, in some embodiments, the publishers 130, the advertisers 140, and the users 110 may be connected (directly or via the network 120) to the database 150, to update the data indicating profiles of one or more users or groups of users and details about users' interaction with and response to specific online content with specific UI elements (provided by the publishers 130). Further, in some embodiments, one or more functionalities and configurations of the personalized UI unit 170 may integrated within a publisher 130, such that the publisher 130 may provide UI personalization for its own users as well as be able to provide UI personalization as a service to other publishers 130 and/or advertisers 140.

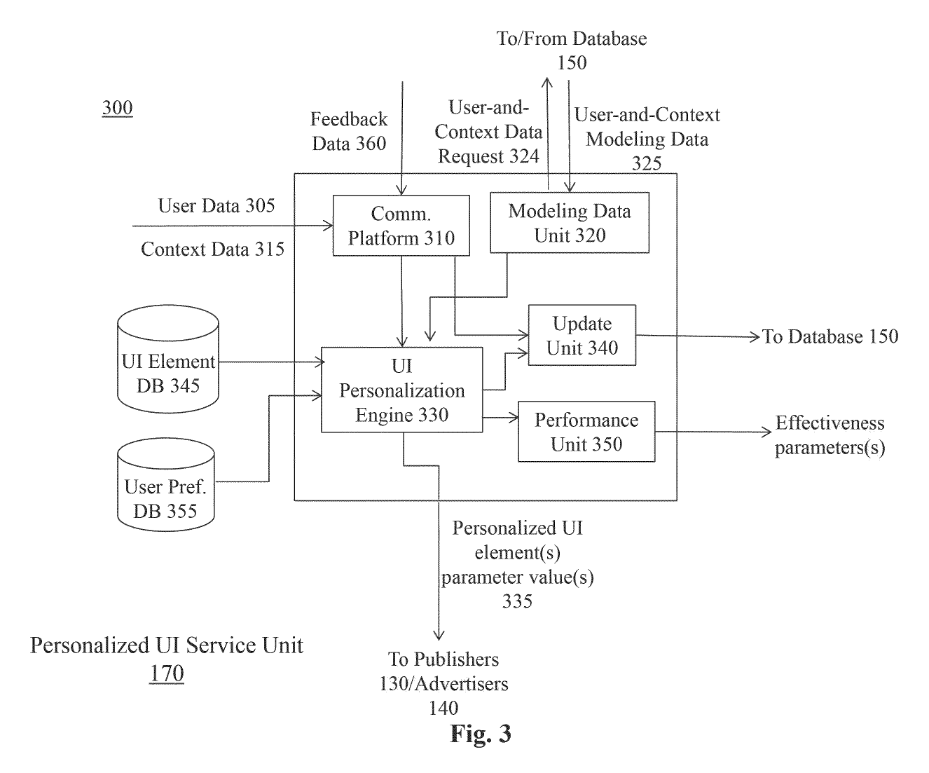

Referring to FIG. 3 which illustrates a high level depiction 300 of an exemplary personalized UI unit 170, according to an embodiment of the present disclosure. As shown, the personalized UI unit 170 may include a communication platform 310, a modeling data analyzer 320, a UI personalization engine 330, a data update unit 340, and a performance measure unit 350. In some embodiments, for a current user session in which a user 110 accesses content and ads at the publisher 130's website/app, the publisher 130 (using embedded javascripts) initiates UI personalization process to personalize one or more UI elements of the provided content/ad for that user 110, in accordance with the embodiments of this disclosure. As part of the UI personalization process, the publisher 130 provides user-related data 305 and context data 315, which are received at the communication platform 310 of the personalized UI unit 170. The user-related data 305 may include information regarding the user (user ID, name, log-in information, etc.) and information related to a device (e.g., user cookie data, IP address, etc.) the user is using to access the publisher's content in the current session. Further, the context data 315 may include various details about the online content/ads (e.g. content topic, content format, search query, etc.) being accessed in the current session. In some embodiments, the publisher 130 (and/or the user 110 and/or the advertiser 140) provides the user data 305 and the context data 315 to a third party for storing a third-party database (not shown), and as such, the publisher 130 may instruct the personalized UI unit 170 to retrieve that data from the third-party database. The communication platform 310 may be configured to check the validity of the received data and forward the received user data 305 and context data 315 to the modeling data unit 320 and the UI personalization engine 330 for further UI personalization processing.

Responsive to (the initiation of) the UI personalization process at the personalized UI unit 170, the modeling data unit 320 may be configured to request and retrieve user-and-context modeling data 325 from the database 150. The modeling data unit/analyzer 320 may analyze the received user data 305 and the context data 315 to determine the data that is to be requested and retrieved from the database 150. For example, based on the indication (in the user data 305) of the identity of the particular user 110, the modeling data unit 320 may generate a data request 324 to obtain user-and-context data 325 (e.g., from the table 200) associated with the profile of the identified user 110. If, however, for example, the profile of user 110 does not exist or is not available, the modeling data unit/analyzer 320 may generate a data request 324 to obtain user-and-context data 325 from the profile(s) of user(s) that match(es) the user 110 in terms of his/her one or more characteristics. Further, instead of, or in addition to, requesting data based on the identity of the user 110, the modeling data unit/analyzer 320 may generate a request 324 for data 325 based on one or more attributes (related to the publisher 130, the type or format of the content, etc.) of the context data 315.

The modeling data unit 320 may send the generated request 324 (e.g., via the communication platform 310) to the database 150, and obtain the relevant or appropriate user-and-context data 325, e.g., from one or more tables 200 in the database 150. The modeling data unit 320 may be configured to confirm validity of the data 325, e.g., whether it fulfills the requirements indicated in the request 324, and if valid, may forward the data 325 to the UI personalization engine 330. In terms of personalizing certain UI elements, the user-and-context modeling data 325 serves as a priori data based on which the user data 305 and the context data 315 is analyzed and processed to determine personalized or optimized UI element(s) value(s).

The UI personalization engine 330, which receives the user data 305, the context data 315, and the user-and-context modeling data 325, may be configured to process the data 305, 315 based on the data 325 to determine a personalized property value of at least one of the UI elements (e.g., font size, font color, background, etc.) of the webpage/app content presented at the device of the user 110 during the current (and/or a subsequent) session. For example, based on the user data 305 and the context data 315, the UI personalization engine 330 may determine that the user 110 is currently accessing a news website (e.g., CNN.com) on a mobile device (e.g., a smartphone). Further, based on the user-and-context data 325, the UI personalization engine 330 may determine that the user 110 (or users similar having profiles as the user 110), when accessing news content on a mobile device, has demonstrated better engagement (in terms of dwell time, click rate, etc.) with sports-related news as compared to other news sections/topics. Accordingly, to ensure the user 110 is easily able to navigate to (and remains engaged with) the sports-related news in the publisher 130's website/app rendered on a relatively small screen size of the user 110's smartphone, the UI personalization engine 330 may identify certain UI elements, and determine or recommend specific parameter/attribute values 335 for the identified UI elements, that highlight the sports-related section of the news content and ads. For example, for the sports-related news/ads, the UI personalization engine 330 may identify font, border, etc. as the relevant UI elements, and generate UI elements' attribute values 335 indicating a different font size, a different font style, a different font color, a different border size or style, etc. than the default attribute values used for other parts of the publisher 130's website/app (for display on the user's smartphone). Specifically, for example, the UI personalization engine 330 may determine that, for personalizing the sports-related news/ads, font size is 12 points (instead of default 10 points), font style is Arial (instead of default Times New Roman), etc.

In some embodiments, the UI personalization engine 330 is operatively connected to a UI element database 345 that stores details about UI elements and their possible attributes' values, e.g., specific to the type of user device, browser, etc. The UI personalization engine 330 may access and use the UI element-related information from the database 345 to determine a possible set of UI elements from which to choose specific UI elements, and determine valid parameter values (or range of values) for the specific UI elements, for personalization purposes. Further, in some embodiments, the UI personalization engine 330 is operatively connected to a UI preference database 355. The database 355 may receive, store and provide preferences of the users 110 in terms of UI elements (e.g. font, background, etc.) they would like to experience when accessing and consuming one or more types of contents from one or more of the publishers 130. Accordingly, in addition to the user data 305 and the context data 315, the UI personalization engine 330 may incorporate UI preference(s) of the user 110 received from the database 355 in determining UI parameter values 335.

The UI personalization engine 330, via, e.g., the communication platform 310, may be further configured to provide the personalized UI parameter values 335 to the publisher 130 (and/or advertiser 140) who requested the personalized UI service. The publisher 130 may configure the content and/or ads in accordance with the personalized UI parameter values 335 and provide the UI-personalized content and ads for rendering on the users 110's device in the current session. For example, the publisher 130 may update or overwrite the default parameter values for the UI elements of the publisher's content with the values indicated in the UI parameter values 335.

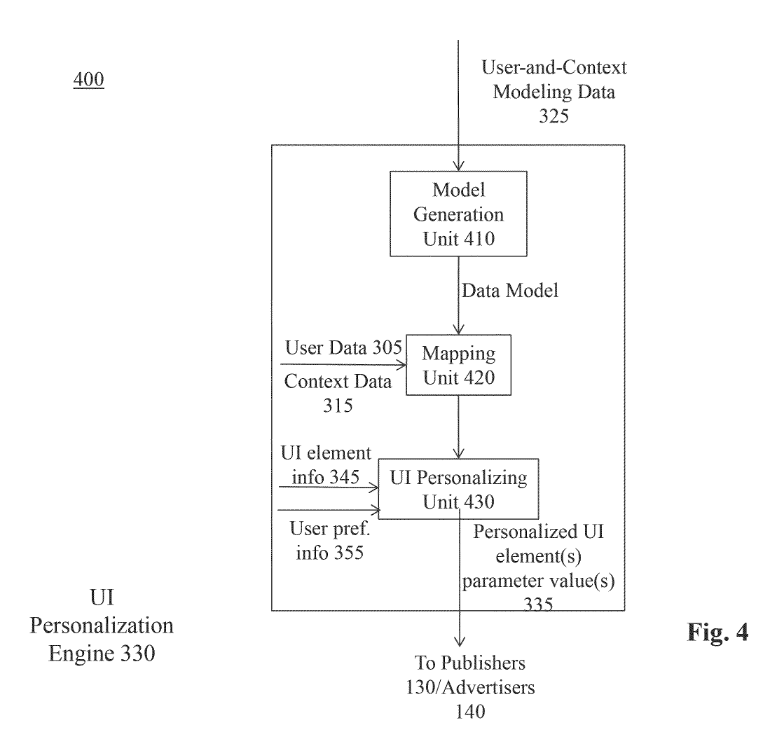

Referring to FIG. 4, which illustrates a high level depiction 400 of an exemplary UI personalization engine 330, according to an embodiment of the present disclosure. As shown, the UI personalization engine 330 may include a model generation unit 410, a mapping unit 420, and a UI personalization unit 430. The model generation unit 410 may receive the user-and-context data 325 (from the modeling data unit 320) which, as discussed above, may include one or more profiles of data in terms of user interaction and response to one or more types of content (having UI elements with certain attributes) provided by one or more publishers 130/advertisers 140 to one or more users 110. In some embodiments, the model generation unit 410 processes the user-and-context data 325 to generate one or more machine-learned models based on a supervised machine-learning model. The possible supervised machine-learning model may include, but not limited to, logistic regression, Bayesian model, Naïve Bayesian model, support vector machine (SVM), and may be used to build classifiers to score each UI element (and/or to score one or more entities of the system 100).

The mapping unit 420 may receive the user data 305 and the context data 315, and apply the machine-learned data model from the model generation unit 410 to the data 305, 315. For example, in accordance with the characteristics of the type of machine-learned data model (logistic regression, Bayesian model, etc.), the mapping unit 420 may assign one or more classes and/or scores to the data 305, 315. Based on the assigned UI-related classes/scores from the mapping unit 420 and information about the UI elements and their possible attribute values from the database 345, the UI personalization unit 430 may select the appropriate personalized parameter values 335 for one or more UI elements (e.g., font size, font color, background, etc.) of the webpage/app content presented at the user 110's device during the current (and/or a subsequent) session. The UI personalization unit 430 may also incorporate user preference information from the database 355 in determining the personalized parameter values 335.

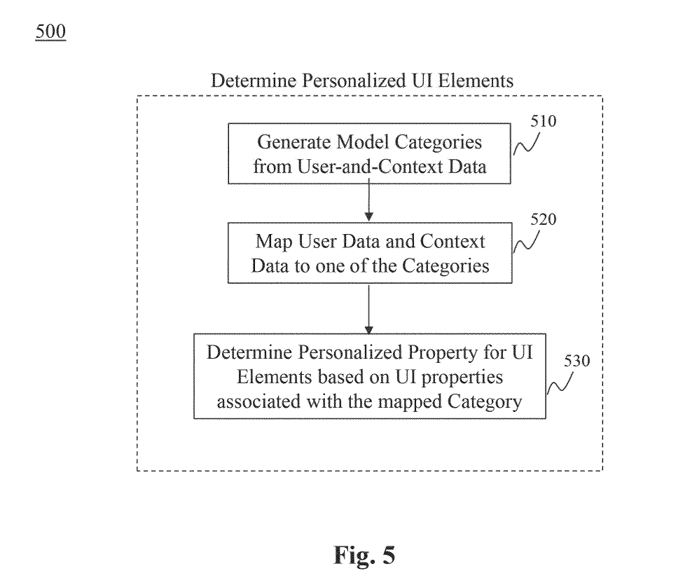

FIG. 5 is a flowchart of an exemplary process 500 operated or executed at UI personalization engine 330, according to the embodiment described above with respect to FIG. 4. At 510, the user-and-context data 325 is processed (e.g., at the model generation unit 410) to determine a machine-learned model for the user-and-context data 325. For example, the model includes into a plurality of categories or classes for different UI elements and their impact on user response. As such, each UI classification category generated by the model is associated with a corresponding set of properties of UI elements. At 520, the user data 305 and the context data 315 is processed (e.g., at the mapping unit 420) and mapped to one of the UI classification categories. At 530, the personalized property or parameter values 335 for one or more UI elements of the webpage/app content are determined using the set of property values of the UI elements corresponding to the one of the UI categories (obtained from the generated model).

Referring back to FIG. 3, in some embodiments, after the content/ads with personalized UI elements are presented to the user 110, the user 110 may provide feedback for the accuracy and/or effectiveness of one or more of the personalized UI elements in his/her interaction and engagement with the publisher 130's website/app. For example, the feedback may include a rating (on a scale of 1-5, etc.) for each of the personalized UI element in the content presented to the user 110 at his/her device during the current session. The user 110 may provide the UI-related feedback data 360 to the associated publisher 130, which then forwards the feedback data 360 to the personalized UI unit 170, or the user 110 may provide the UI-related feedback data 360 to the personalized UI unit 170. As such, the feedback data 360 is received at the communication platform 310, which may forward the feedback data 360 to the update unit 340. The update unit 340 may process and format the feedback data in the structure appropriate for the database 150. Further, the update unit 340 may then send out the formatted feedback data 360 to the database 150 to update or add in the profile of the user 110 (or the profiles of the group of users similar to the user 110) who provided the feedback data 360. In other words, the user-and-context data 325 for the user 110 (or similar users) is updated based on the feedback data 360.

The update unit 340 may receive the user data 305 and the context data 315 from the communication platform 310 or the UI personalization engine 320 to be sent to the database 150. For example, (after or while the engine 320 is determining the personalized UI parameters, the update unit 340 may process and format the user data 305 and the context data 315 (related to the current session) in the structure appropriate for the database 150. Further, the update unit 340 may then send out the formatted data 305, 315 to the database 150 to update or add in the profile of the user 110 (or the profiles of the group of users similar to the user 110) who is associated with data 305, 315. In other words, the user-and-context data 325 for the user 110 (or similar users) is updated based on the user data 305 and the context data 315. Accordingly, based on the feedback 360 and the data 305, 315, the profiles at the database 150 may reflect a continuously improving data set based on which the personalized UI service unit 170 may determine better personalized UI parameter values.

Further, in some embodiments, based on the user data 30, the context data 315 and/or the feedback data 360, the performance unit 350 determines or assigns an “effectiveness” parameter or rating for the UI elements that were personalized or optimized by the engine 330 and presented to a certain user 110. The effectiveness parameter may indicate a degree of effectiveness of each of the personalized UI elements presented to a certain user. The effectiveness parameter can be characterized in terms of user engagement activity that the user has demonstrated with the website/app when presented with personalized UI element(s). Such user engagement activity, which may be indicated by the user data 305 and/or the context data 315, may include click-through, hover, dwell, close/cancel, conversion, purchase, install, activation, abandonment with respect to content and/or ads of the website/app. The performance unit 350 may determine the effectiveness parameter based on the user data 305, the context data 315 and/or the feedback data 360 in terms of user-related values, e.g., sessions per user per day, total dwell per user per day, total conversion/purchase per user per day, and/or similar user-activity related measurements. In some embodiments, the performance unit 350 is configured to update the profile of the user 110 (in the database 150) for whom the effectiveness parameter has been determined In that respect, the performance unit 350 transmits the determined effectiveness parameter for the user 110 to the database 150, where the user-and-context modeling data (or user profile) in the database 150 for the user 110 is adapted or updated based on the effectiveness parameter.

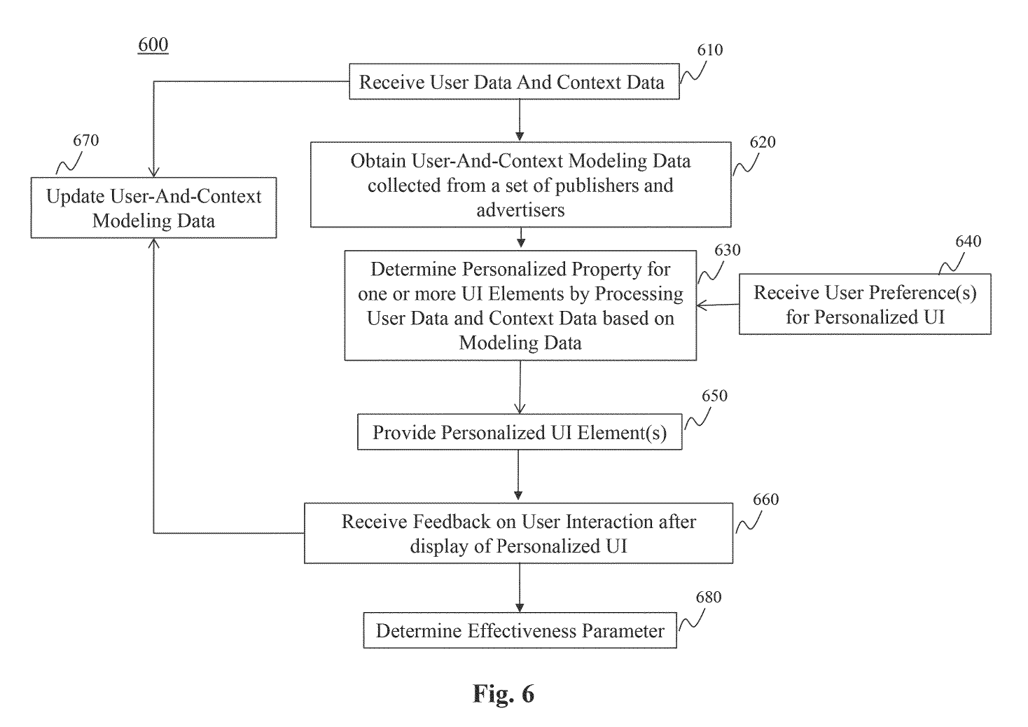

FIG. 6 is a flowchart of an exemplary process 600 operated or executed at the personalized UI service unit 170, according to the embodiment described above with respect to FIG. 3. At 610, the user data 305 and the context data 315 is received, e.g., at the communication platform 310. At 620, the user-and-context modeling data 325 is obtained (e.g., from the database 150) and processed (e.g., at modeling unit 320). The user data 305, the context data 315 and the user-and-context data modeling data 325 is provided, e.g., to the UI personalization engine 330. The user preference data from database 355 may also be provided to the engine 330 (640). At 630, the engine 330 may process the user data 305 and the context data 315 (and the user preference data) based on the user-and-context data modeling data 325 (and UI element information from the database 345) to determine the personalized property or parameter values 335 for one or more UI elements of the webpage/app content presented to the user 110 during the current session. At 650, the personalized property or parameter values 335 for one or more UI elements are provided to the publisher 130/advertiser 140 who initiated or requested the UI personalization process.

At 660, after the content with personalized UI elements are presented at the user 110′s device, the feedback data 360 from the user with regard to the accuracy/effectiveness of the personalization is received, e.g., at the update unit 340. At 670, using the data 305, 315 and the feedback data 360, the update unit 340 updates the profile of the user 110 (or the profiles of the group of users similar to the user 110) at the database 150. At 680, based on the feedback data 360, an effectiveness parameter or rating is determined or assigned (e.g., by the performance unit 350) for one or more of the UI elements that were personalized or optimized by the engine 330.

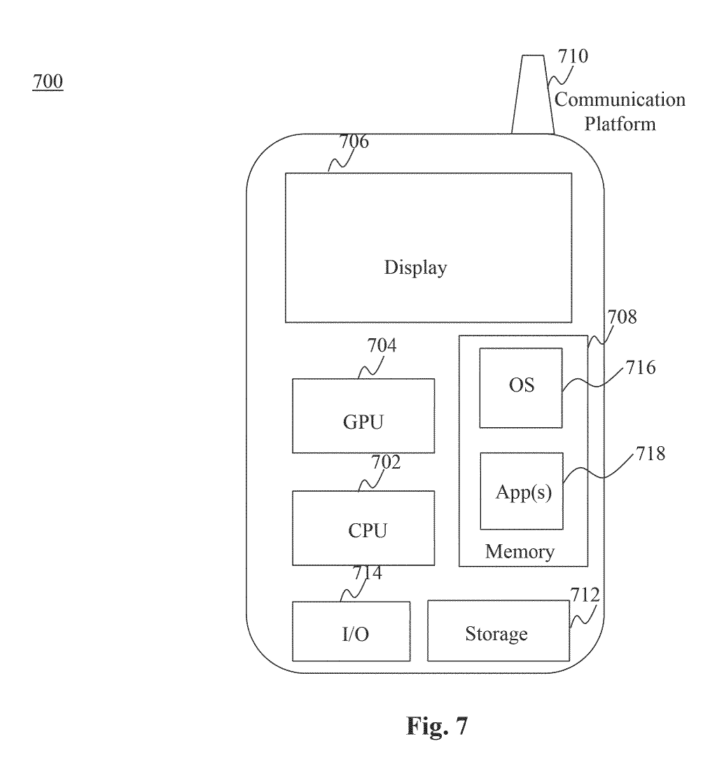

FIG. 7 depicts a general mobile device architecture on which the present teaching may be implemented. In this example, the user device on which content and advertisement are presented and interacted-with is a mobile device 700, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 700 in this example includes one or more central processing units (CPUs) 702, one or more graphic processing units (GPUs) 704, a display 706, a memory 708, a communication platform 710 (such as a wireless communication module), storage 712, and one or more input/output (I/O) devices 714. Any other suitable component, such as but not limited to a system bus or a controller (not shown), may also be included in the mobile device 700. As shown in FIG. 7, a mobile operating system 716, e.g., iOS, Android, Windows Phone, etc., and one or more applications 718 may be loaded into the memory 708 from the storage 712 in order to be executed by the CPU 702. The applications 718 may include a browser or any other suitable mobile apps for receiving and rendering content streams and advertisements on the mobile device 700. User interactions with the content streams and advertisements may be achieved via the I/O devices 714 and provided to the publishers 130, the advertisers 140 and/or the unit 170 and/or other components of system 100, e.g., via the network 120.

To implement various modules, units, and their functionalities described in the present disclosure, computer hardware platforms may be used as the hardware platform(s) for one or more of the elements described herein (e.g., the publishers 130, the advertisers 140 and/or the unit 170 and/or other components of system 100 described with respect to FIGS. 1-6). The hardware elements, operating systems and programming languages of such computers are conventional in nature, and it is presumed that those skilled in the art are adequately familiar therewith to adapt those technologies to the UI personalization techniques described herein. A computer with user interface elements may be used to implement a personal computer (PC) or other type of work station or terminal device, although a computer may also act as a server if appropriately programmed It is believed that those skilled in the art are familiar with the structure, programming and general operation of such computer equipment and as a result the drawings should be self-explanatory.

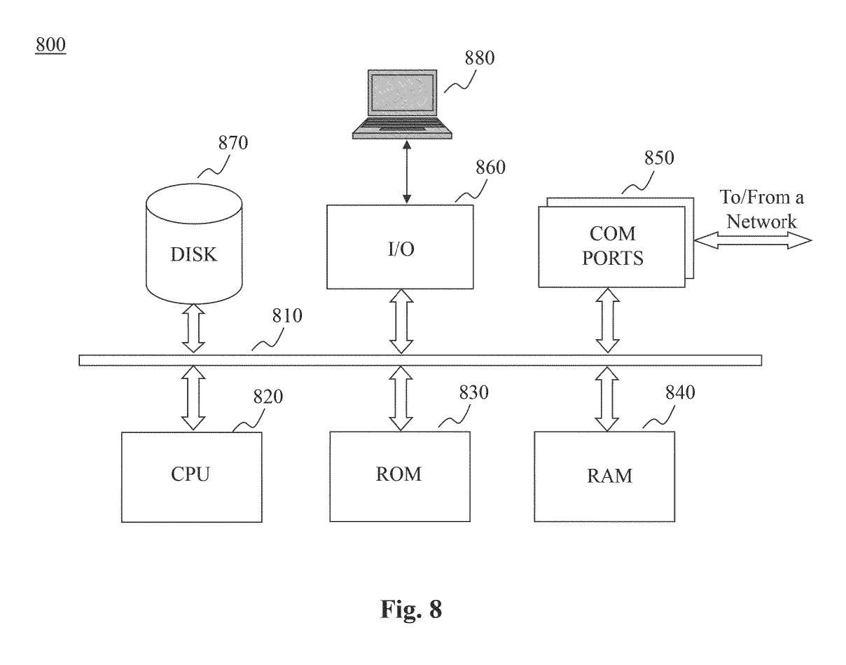

FIG. 8 depicts a general computer architecture on which the present teaching may be implemented and has a functional block diagram illustration of a computer hardware platform which includes user interface elements. The computer may be a general purpose computer or a special purpose computer. This computer 800 may be used to implement any component of the UI personalization techniques, as described herein. For example, the unit 170, etc., may all be implemented on a computer such as computer 800, via its hardware, software program, firmware, or a combination thereof. Although only one such computer is shown, for convenience, the computer functions relating to UI personalization may be implemented in a distributed fashion on a number of similar platforms, to distribute the processing load.

The computer 800, for example, includes COM ports 850 connected to and from a network connected thereto to facilitate data communications. The computer 800 also includes a central processing unit (CPU) 820, in the form of one or more processors, for executing program instructions. The exemplary computer platform includes an internal communication bus 810, program storage and data storage of different forms, e.g., disk 870, read only memory (ROM) 830, or random access memory (RAM) 840, for various data files to be processed and/or communicated by the computer, as well as possibly program instructions to be executed by the CPU. The computer 800 also includes an I/O component 860, supporting input/output flows between the computer and other components therein such as user interface elements 880. The computer 800 may also receive programming and data via network communications.

Hence, aspects of the methods of personalizing or optimizing UI elements and/or other processes, as outlined above, may be embodied in programming Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming

All or portions of the software may at times be communicated through a network such as the Internet or various other telecommunication networks. Such communications, for example, may enable loading of the software from one computer or processor into another, for example, from a management server or host computer of the search engine operator or other explanation generation service provider into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the UI personalization as disclosed herein may be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform capable of making a connection to a network to personalize one or more user interface (UI) elements, the method comprising:
receiving, via the communication platform, data related to a user and context data including information related to a webpage or an application to be accessed by the user on a user device, wherein the webpage or the application includes one or more UI elements;
obtaining user-and-context modeling data related to a plurality of users and a plurality of webpages and applications; and
determining a personalized property with respect to at least one of the one or more UI elements to be used to present the webpage or the application at the user device based on the data related to the user and the context data in accordance with the user-and-context modeling data.

2. The method of claim 1, further comprising providing, via the communication platform, the personalized property of the at least one of the one or more UI elements such that the webpage or the application is made available on the user device based on the personalized property.

3. The method of claim 1, further comprising updating user-and-context modeling data based on the data related to the user and the context data.

4. The method of claim 1, further comprising:
receiving, via the communication platform, feedback data related to user interaction with the webpage or the application upon the user accessing the webpage or the application rendered on the user device according to the personalized property;
determining an effectiveness parameter of UI personalization based on the feedback data; and
adapting the user-and-context modeling data based on the effectiveness parameter.

5. The method of claim 1, further comprising receiving, from the user via the communication platform, a preference parameter related to the at least one of the one or more UI elements.

6. The method of claim 1, wherein said determining a personalized property comprises:
generating a plurality of model categories based on the user-and-context modeling data, wherein each of the model categories is associated with a corresponding set of properties of UI elements;
mapping the data related to the user and the context data to at least one of the model categories; and
selecting the personalized property with respect to the at least one of the one or more UI elements based on the at least one of the model categories.

7. The method of claim 1, wherein the data related to the user comprise at least one of user cookie data, user device IP address, user geographical location data, type of user device, and data indicating user interaction with the webpage or application.

8. The method of claim 1, wherein the context data comprise at least one of uniform resource locator (URL) of the webpage, contents of the webpage or the application, type of browser, and a query submitted by the user.

9. The method of claim 1, wherein the one or more UI elements comprise at least one of font, page layout, background, border, length of search results, and image/thumbnail placement rules.

10. A machine readable, tangible, and non-transitory medium having information recorded thereon to personalize one or more user interface (UI) elements, where the information, when read by the machine, causes the machine to perform at least the following:
receiving data related to a user and context data including information related to a webpage or an application to be accessed by the user on a user device, wherein the webpage or the application includes one or more UI elements;
obtaining user-and-context modeling data related to a plurality of users and a plurality of webpages and applications; and
determining a personalized property with respect to at least one of the one or more UI elements to be used to present the webpage or the application at the user device based on the data related to the user and the context data in accordance with the user-and-context modeling data.

11. The medium of claim 10, wherein the machine is caused to further perform providing the personalized property of the at least one of the one or more UI elements such that the webpage or the application is made available on the user device based on the personalized property.

12. The medium of claim 10, wherein the machine is caused to further perform updating user-and-context modeling data based on the data related to the user and the context data.

13. The medium of claim 10, wherein the machine is caused to further perform:
receiving feedback data related to user interaction with the webpage or the application upon the user accessing the webpage or the application rendered on the user device according to the personalized property;
determining an effectiveness parameter of UI personalization based on the feedback data; and
adapting the user-and-context modeling data based on the effectiveness parameter.

14. The medium of claim 10, wherein the machine is caused to further perform receiving, from the user, a preference parameter related to the at least one of the one or more UI elements.

15. The medium of claim 14, wherein said determining is further based on the preference parameter.

16. The medium of claim 10, wherein said determining a personalized property comprises:
generating a plurality of model categories based on the user-and-context modeling data, wherein each of the model categories is associated with a corresponding set of properties of UI elements;
mapping the data related to the user and the context data to at least one of the model categories; and
selecting the personalized property with respect to the at least one of the one or more UI elements based on the at least one of the model categories.

17. The medium of claim 10, wherein the data related to the user comprise at least one of user cookie data, user device IP address, user geographical location data, type of user device, and data indicating user interaction with the webpage or application.

18. The medium of claim 10, wherein the context data comprise at least one of uniform resource locator (URL) of the webpage, contents of the webpage or the application, type of browser, and a query submitted by the user.

19. The medium of claim 10, wherein the one or more UI elements comprise at least one of font, page layout, background, border, length of search results, and image/thumbnail placement rules.

20. A system to personalize one or more user interface (UI) elements, the system comprising:
a communication platform configured to receive data related to a user and context data including information related to a webpage or an application to be accessed by the user on a user device, wherein the webpage or the application includes one or more UI elements;
a modeling data unit configured to obtain user-and-context modeling data related to a plurality of users and a plurality of webpages and applications; and
a UI personalization engine configured to determine a personalized property with respect to at least one of the one or more UI elements to be used to present the webpage or the application at the user device based on the data related to the user and the context data in accordance with the user-and-context modeling data.

21. The system of claim 20, wherein the communication platform is further configured to provide the personalized property of the at least one of the one or more UI elements such that the webpage or the application is made available on the user device based on the personalized property.

22. The system of claim 20, further comprising an update unit to update user-and-context modeling data based on the data related to the user and the context data.

23. The system of claim 20, wherein the communication platform is further configured to receive feedback data related to user interaction with the webpage or the application upon the user accessing the webpage or the application rendered on the user device according to the personalized property,
the system further comprising an performance unit configured to determine an effectiveness parameter of UI personalization based on the feedback data, and adapt the user-and-context modeling data based on the effectiveness parameter.

24. The system of claim 20, wherein said UI personalization engine comprises:
a model generation unit configured to generate a plurality of model categories based on the user-and-context modeling data, wherein each of the model categories is associated with a corresponding set of properties of UI elements;
a mapping unit configured to map the data related to the user and the context data to at least one of the model categories; and
a UI personalizing unit configured to select the personalized property with respect to the at least one of the one or more UI elements based on the at least one of the model categories.

25. The system of claim 20, wherein:
the data related to the user comprise at least one of user cookie data, user device IP address, user geographical location data, type of user device, and data indicating user interaction with the webpage or application,
the context data comprise at least one of uniform resource locator (URL) of the webpage, contents of the webpage or application, type of browser, and a query submitted by the user, and
the one or more UI elements comprise at least one of font, page layout, background, border, length of search results, and image/thumbnail placement rules.
